(19) United States
(12) Patent Application Publication
(10) Pub. No.: US 2024/0161512 A1
(43) Pub. Date: May 16, 2024

(54) TRAINING FOR IMAGE SIGNAL PROCESSING ALGORITHM ITERATIONS FOR AUTONOMOUS VEHICLES

(71) Applicant: Baidu USA LLC, Sunnyvale, CA (US)

(72) Inventors: SHU JIANG, Sunnyvale, CA (US); SZU-HAO WU, Sunnyvale, CA (US); JEONG HO LYU, Sunnyvale, CA (US); LINPENG CHENG, Sunnyvale, CA (US); HAO LIU, Sunnyvale, CA (US); HELEN K. PAN, Sunnyvale, CA (US)

(21) Appl. No.: 17/988,479

(22) Filed: Nov. 16, 2022

(51) Int. Cl. G06V 20/58; G06N 3/0464; G06V 10/764; G06V 10/774; G06V 10/82

(52) U.S. Cl. CPC G06V 20/58; G06N 3/0464; G06V 10/764; G06V 10/774; G06V 10/82

(57) ABSTRACT

In one embodiment, a system generates an image using either a first or a second image signal processing (ISP) algorithm, where the first or second ISP algorithm is applied to raw image data of a camera of an autonomous driving vehicle (ADV) to generate the image. The system applies a machine learning model to the image to identify a representation of an obstacle, where the machine learning model is generated by a few shots learning algorithm that contrasts labeled data of a positive training sample from images corresponding to the first and second ISP algorithms to labeled data of a negative training sample from images corresponding to the first and second ISP algorithm. The system determines a classification and a location of the obstacle based on the representation of the obstacle. The system plans a motion control of the ADV based on the classification and location of the detected object.

### TECHNICAL FIELD

Embodiments of the present disclosure relate generally to operating autonomous driving vehicles. More particularly, embodiments of the disclosure relate to training for image signal processing algorithm iterations for autonomous driving vehicles (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Image signal processors (ISP) are used to process image data for camera systems of autonomous driving vehicles (ADVs). An ISP is used to preprocess raw image data by applying ISP algorithms such as demosaic, black level balancing, denoising, color adjustments, and so forth, to the raw image data.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a machine learning engine according to one embodiment.

FIG. 5 is a block diagram illustrating an example of an obstacle perception module according to one embodiment.

FIG. 6A is a block diagram illustrating an example of an image signal processor (ISP) according to one embodiment.

FIG. 6B illustrates an example of an output of obstacle perception module according to one embodiment.

FIG. 7 is a block diagram illustrating an example of training data augmentation according to one embodiment.

FIGS. 8A-8B are block diagram illustrating an example of a machine learning (ML) model for training according to one embodiment.

FIG. 9 is a flow diagram illustrating a process to train a ML model using few shot learning according to one embodiment.

FIG. 10 is a flow diagram illustrating a process to perform inference using a ML model according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a few shot training approach is used to train a machine learning (ML) model having a transfer network adaptive to captures features from images of new image signal processing (ISP) algorithms, where a few labeled data corresponding to the new ISP algorithms are used for the training. Using the few shot training approach, a ML model that is previously trained using images from a baseline ISP algorithm can be fitted for newly proposed ISP algorithms without having to prepare a full set of labeled training data using images of the newly proposed ISP algorithms.

ISP algorithms can be used by an image signal processor to process raw image data from camera sensors of an autonomous driving vehicle (ADV) to generate red-green-blue (RGB) color images. The color images can be used for downstream perception tasks, such as machine learning (ML) inference tasks to identify obstacles in a surrounding of the ADV.

Currently, ML models are trained using a baseline ISP algorithm (baseline ISP algorithm being a starting point ISP algorithm). When a new ISP algorithm is proposed due to changes in camera sensor hardware configurations or experimental results that indicate the new ISP algorithm results in a higher inference accuracy for downstream ML models, implementing the new ISP algorithms may require downstream ML models to be retrained since the input images are altered by the new ISP algorithms. Currently, the downstream perception tasks include ML models that are trained based on baseline images corresponding to a baseline ISP algorithm. When the ISP algorithm changes, downstream ML models are retrained with training data from the newly proposed ISP algorithm. For supervised models, a full set of training data for the new ISP algorithm needs to be prepared (e.g., labeled). This requirement to generate a full set of training data for each new ISP algorithm implemented is costly.

According to a first aspect, a system determines a first set of images corresponding to a first image signal processing (ISP) algorithm, where the first set of images includes corresponding labeled data. The system determines a second set of images corresponding a second ISP algorithm, where the second set of images includes a predetermined threshold number of labeled data. The system determines a batch of positive training samples from both the first set of images and the second set of images, the positive training samples having a same category of obstacles. The system determines a batch of negative training samples from both the first set of images and the second set of images, the negative training samples having different categories of obstacles. The system trains a machine learning model using a few shot learning algorithm by applying the batches of positive and negative training samples to the machine learning model, where the machine learning model is used to detect an obstacle in an image that is generated using either the first or the second ISP algorithm, where the first or second ISP algorithm is applied to raw image data of a camera of an autonomous driving vehicle (ADV) to generate the image for perception tasks of the ADV. The machine learning model includes a transfer neural network that is adaptive to the first and second ISP algorithms and can infer from images generated by either the first or second ISP algorithms.

According to a second aspect, a system receives an image corresponding to either a first or a second image signal processing (ISP) algorithm, where the first or second ISP algorithm is applied to raw image data of a camera of an autonomous driving vehicle (ADV) to generate the image. The system applies a machine learning model to the image to identify a representation of an obstacle, where the machine learning model is generated by a few shot learning algorithm that contrasts labeled data of a positive training sample from images corresponding to the first and second ISP algorithms to labeled data of a negative training sample from images corresponding to the first and second ISP algorithms. The system determines a classification and a location of the obstacle based on the representation of the obstacle. The system plans a motion control of the ADV based on the classification and location of the obstacle.

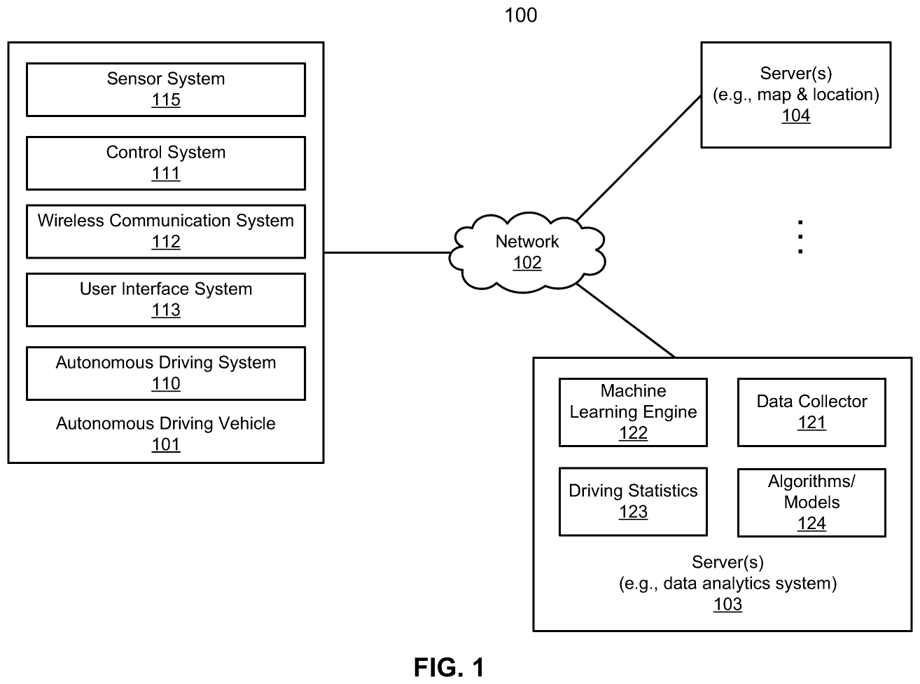

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

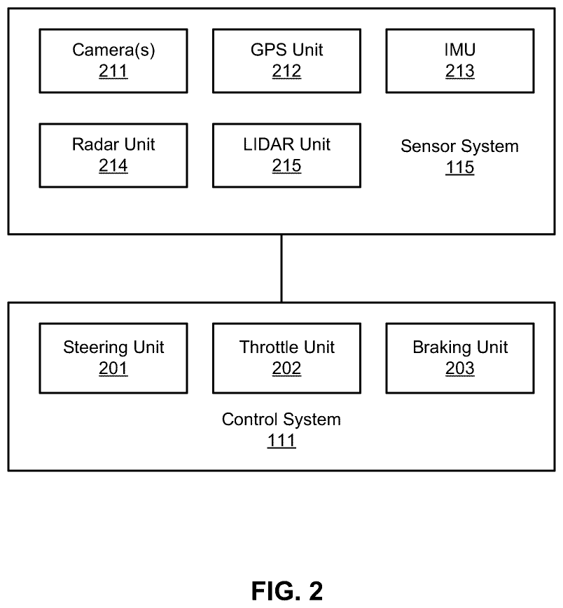

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

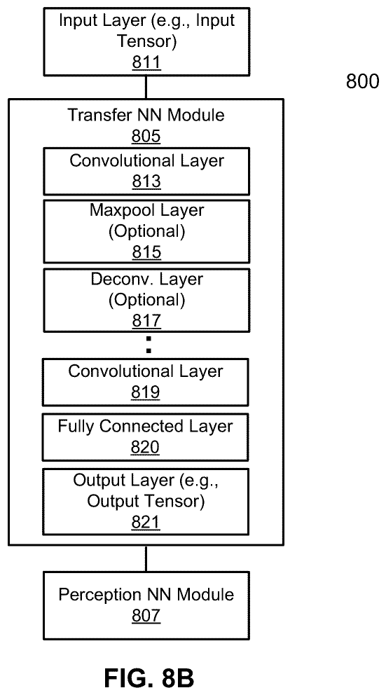

Based on driving statistics 123, machine learning engine 122 generates or trains a set of rules, algorithms, and/or predictive models 124 for a variety of purposes. In one embodiment, algorithms 124 can include a machine learning model used for perception tasks. The machine learning model can include a transfer module and a perception module. The transfer module can include one or more convolutional layers adaptive to new ISP algorithms. The perception module can include a convolutional neural network (CNN) model that is previously trained to infer from a baseline ISP algorithm. An example of a machine learning model is shown in FIGS. 8A-8B.

Algorithms 124 can further include one or more ISP algorithms that can be applied to raw image data of camera sensors to generate images. The ISP algorithms can include any one or a combination of: image format conversion, image resize, exposure adjustment, black level adjustment, color adjustment, pixel correction, color interpolation, de-noise algorithms, and so forth.

Algorithms 124 can be uploaded on ADVs to be utilized during autonomous driving in real-time.

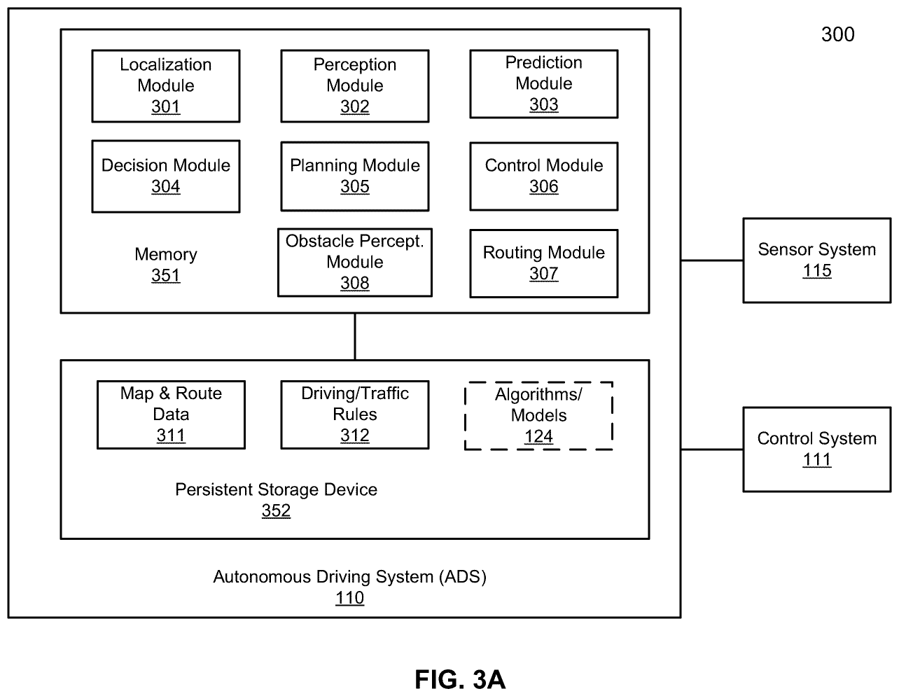

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and obstacle perception module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

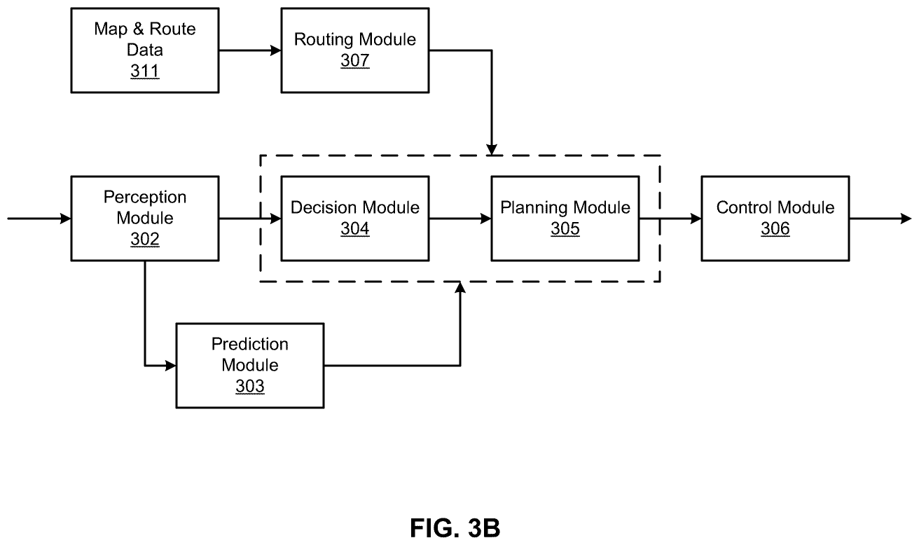

FIG. 4 is a block diagram illustrating an example of a machine learning engine 122 according to one embodiment. Machine learning (ML) engine 122 can train a ML model for perception tasks for the ADV. In one embodiment, ML engine 122 includes submodules such as training image determiner 401, positive samples determiner 403, negative samples determiner 405, machine learning model generator 407, and machine learning model trainer 409. Training image determiner 401 can determine sets of images corresponding to an image signal processing (ISP) algorithm. The set of images can correspond to a new ISP algorithm. The set of images can be labeled/annotated with anchor boxes (or bounding boxes) surrounding obstacles of one or more classifications that the ML model intents to detect. In another embodiment, the set of images can correspond to a baseline ISP algorithm (e.g., a starting point ISP algorithm where images corresponding to the baseline ISP algorithm is used to pretrain a ML model). Positive samples determiner 403 can determine one or more positive training samples. A positive training sample can include a pair of images containing bounding boxes with a same class of obstacles, where one image is from the new ISP algorithm and another image is from the baseline ISP algorithm.

Negative samples determiner 405 can determine one or more negative training samples. A negative training sample can include a pair of images containing bounding boxes with different classes of obstacles, where one image is from the new ISP algorithm and another image is from the baseline ISP algorithm. Machine learning model generator 407 can generate a trainable ML model. Machine learning model trainer 409 can train the trainable ML model.

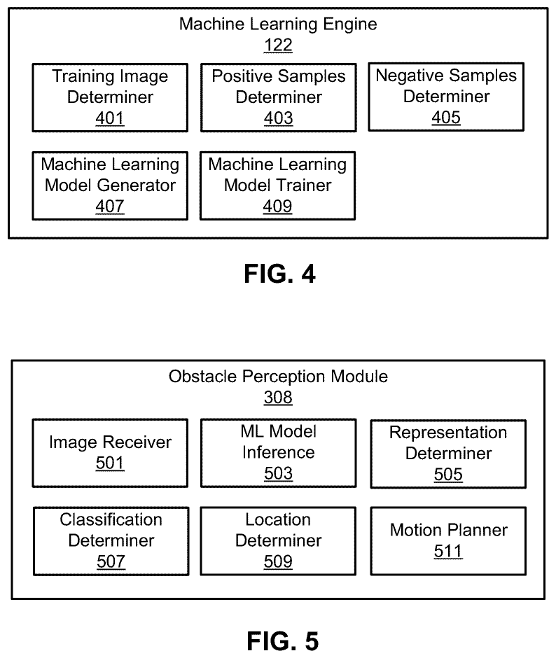

FIG. 5 is a block diagram illustrating an example of an obstacle perception module 308 according to one embodiment. Obstacle perception module 308 can apply a ML model to images of a camera sensor to detect obstacles in the images. In one embodiment, obstacle perception module 308 includes submodules such as image generator 501, ML model inference 503, representation determiner 505, classification determiner 507, location determiner 509, and motion planner 511.

Image receiver 501 can receive images from camera sensors, where the images are preprocessed by an ISP that applies one or more ISP algorithms to raw image data from the camera sensors. ML model inference 503 can apply a ML model to the images to perform inferencing. Representation determiner 505 can determine the output of the ML inferencing to obtain representations of the obstacles. The representations of the obstacles can include a classification value for each obstacle detected in an image and locations/dimensions of bounding boxes for each detected obstacle. Classification determiner 507 can determine the classification of detected obstacles. Some classifications can include vehicle, bus, train, truck person, bicycle, motorcycle, traffic light signals, etc. Location determiner 509 can determine the location of a detected obstacle from bounding boxes detected from the images. In one embodiment, location determine 509 projects the bounding boxes to the three-dimensional space to determine an approximate x-y-z coordinate of the obstacle. Motion planner 511 can plan a motion control of the ADV according to the detected obstacles. For example, if an obstacle vehicle is detected in front of the ADV, motion planner 511 can plan a motion (a path and a velocity) for ADV to follow the detected vehicle in front of the ADV while keeping a safe distance.

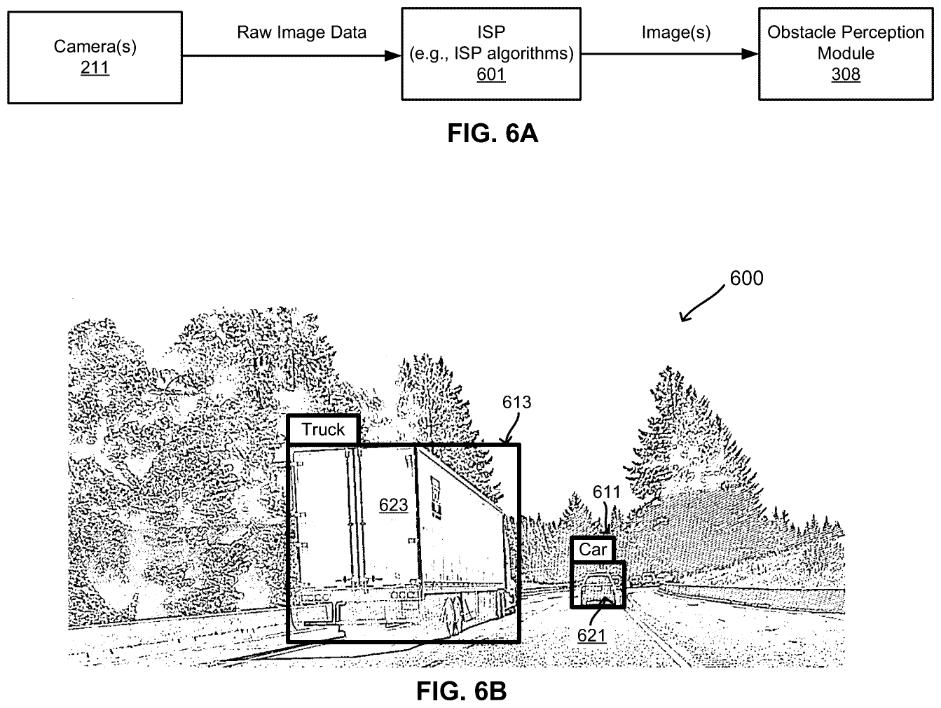

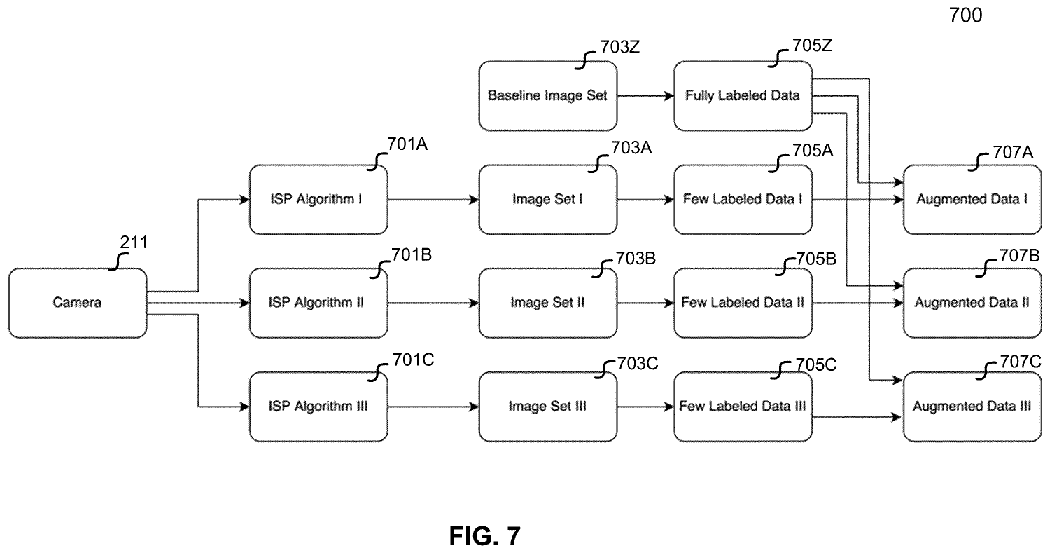

FIG. 6A is a block diagram illustrating an example of an image signal processor (ISP) 601 according to one embodiment. In one embodiment, a sensor system (such as system 115 of FIG. 1) can configure ISP 601 in real-time using ISP configuration parameters corresponding to one or more ISP algorithms. Once configured, when camera(s) 211 capture raw image data, ISP 601 applies an ISP algorithm (corresponding to the configured ISP algorithm) to the raw image data to generate the output image(s). The output images can be used by downstream perception tasks. For example, output images can be used obstacle perception module 308 for obstacle detection.

In one embodiment, an ISP algorithm can be configured in real-time by the ADV when the ADV is in motion. An ISP algorithm can include any one or a combination of: image format conversion, image resize, exposure adjustment, black level adjustment, color adjustment, pixel correction, color interpolation, and/or de-noise algorithms. Once configured, the ISP algorithm can be used to preprocess raw image data to generate images for machine learning (ML) applications. Note that the generated images may not correspond to images seem by human perception. For example, the images can be preprocessed to contrasts the reds from the greens to increase the accuracy of inferencing a red traffic light from a green traffic light. For example, a proposed ISP algorithm can convert green colors to turquoise colors if it is determined that turquoise colors can improve a ML inference accuracy to detect green colors under various environmental lightings and weather conditions. Although ISP algorithm for a color transformation is illustrated as the example, different transformations can be applied to raw image data to improve inference accuracy for certain features detections.

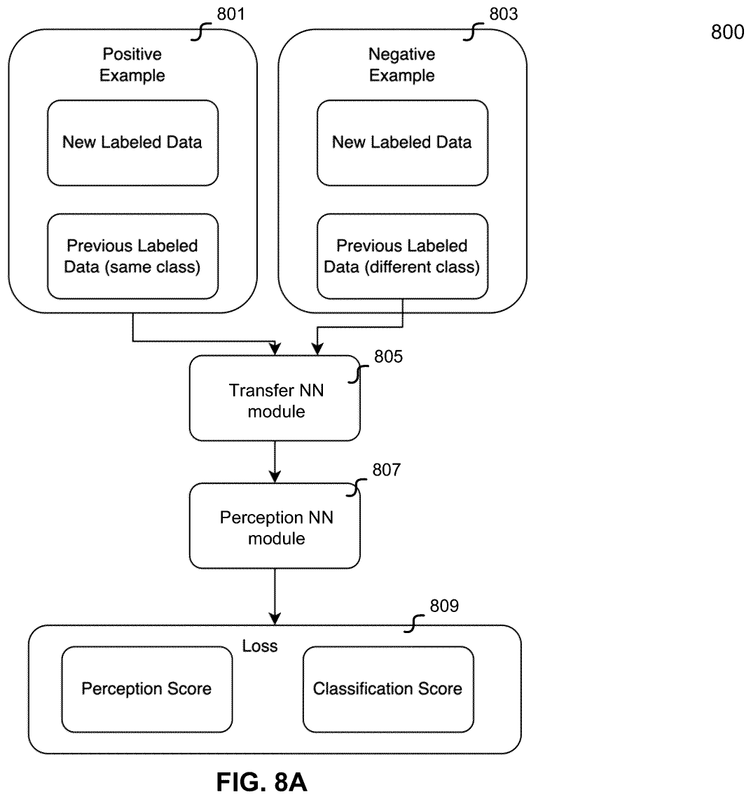

FIG. 6B illustrates an example of an inference output 600 for obstacle perception module 308 according to one embodiment. Module 308 can apply a ML model to an image to generate output 600 with output label listings 611-613. Label listings 611-613 can correspond to one or more obstacles that are detected in the image. In one embodiment, output label listings 611-613 correspond to anchor boxes (or bounding boxes) that represent the detected obstacles 621-623 (e.g., representations of obstacles 621-623). A listing of anchor boxes 611-613 and their coordinates can be generated as an output of a ML model. An anchor box can be rectangular-shaped and surrounds a detected obstacle, e.g., obstacles 621-623. The listing for anchor boxes 611-613 can further indicate a classification for the detected obstacles, e.g., truck, car, etc. Using anchor box 611, module 308 can determine corresponding locations of obstacles 621-623. For example, module 308 can map the sizes of bounding boxes 611-613 to an expected size of the class of the obstacles to approximate distances to the obstacles, or use a combination of the expected size and a distance measurement sensor, such as LIDAR, RADAR, or the like, to approximate a distance to obstacles 621-623. Since detecting the obstacles and observing a distance to the obstacles is critical for autonomous driving, modifying the ISP algorithms changes the input image data and requires the downstream ML model at module 308 to be fitted with the new input image data. FIGS. 7-8 illustrate a few shot learning process that can reduce the labeling requirement to fit the ML model to input image data of newly proposed ISP algorithms.

FIG. 7 is a block diagram illustrating an example of training data augmentation according to one embodiment. Example 700 shows examples of training data to train a ML model using few shot learning. When a new ISP algorithm is proposed for supervised learning, training data from example 700 corresponding to the new ISP algorithm can be used for ML model training. FIG. 7 shows three ISP algorithms are proposed. ADV can capture raw image data using camera 211 of the ADV. The raw image data can then be processed by ISP algorithms I-III 701A-701C to generate corresponding image sets I-III 703A-703C. An operator can process the image sets I-III to provide a few labeled data I-III 705A-705C. Although three algorithms (I, II, and III) are shown, the ISP algorithms can include any number of newly proposed ISP algorithms.

For purposes of illustration, if a model is to classify five types of obstacles, e.g., car, pedestrian, bike, traffic light, truck, the few shot labeled data I 705A for ISP algorithm I can include a few labeled data (such as 1-5 labeled data) for each class of obstacle for the training. E.g., 1 sample for car, 1 sample for pedestrian, 1 sample for bike, 1 sample for traffic light, and 1 sample for truck as sample data 705A for ISP algorithm I. A ML engine, such as ML engine 122 of FIG. 4, can automatically combine the 5 labeled sample data 705A for ISP algorithm I with baseline labeled data 705Z from a baseline image set 703Z to generate positive and negative training samples for a few shot learning. For example, if the baseline labeled data 705Z has 100 labeled data, e.g., 20 for each classification, engine 122 can generate the total labeled data to be 500 augmented samples 707A. From the 500 labeled data, 100 can be positive samples and 400 can be negative samples. Each positive sample can include a pair of labeled data in a same class, e.g., one from 705A and one from 705Z such that there are: 1 of ISP I*20 of baseline*5 classes=100 positive sample pairs.

For the negative training samples, each negative sample can include a pair of labeled data from a different class, e.g., one from 705A and one from 705Z such that there are: 1 of ISP I*80 of baseline*5 classes=400 negative sample pairs. In summary, each pair includes a labeled data from 705A and a labeled data from 705Z. The positive samples can include labeled data from a same classification (e.g., bike vs. bike, car vs. car, truck vs. truck, etc.) and the negative samples can include labeled data from different classifications (e.g., bike vs. car, bike vs. truck, bike vs. pedestrian, bike vs. traffic light, car vs. bike, car vs. truck, car vs. pedestrian, car vs. traffic light, etc.).

Similar augmentation can be applied to labeled data 705B-705C for images 703B-703C generated by ISP algorithms II-III 701B-701C to generate augmented data 707B-707C as described above. Although 5 labeled data for 705A, 100 labeled data for 705Z, and five classifications are used for purposes of illustration, 705A-705Z can include any number of labeled data and ML model can classify any number of classes of obstacles for the few shot learning. Note that a ratio 1:4 for the positive to negative samples is used for purposes of illustration, but the ratio can be any number of positive to negative samples.

Currently, most supervised deep learning rely on a tremendous amount of labeled data to learn useful representations. Few shot learning (FSL) or N-way-K-Shot-classification learning can classify new data when there is only a few training samples with supervised information (e.g., labeled data) available, where N denotes the number of classes and K denotes the number of labeled sample data from each class for the training, where K can be any integer value greater than or equal to zero. When FSL is combined with transfer learning and contrastive learning, a ML model can quickly adapt to new ML tasks. Note that transfer learning refers to a machine learning technique where a model trained on one task is repurposed for a second related task. For example, a model trained to classify objects using images from a baseline ISP algorithm can be repurposed to classify objects using images from newly proposed ISP algorithms. Contrastive learning refers to the learning approach that seeks to quantify the similarly or dissimilarity between data elements. A loss function that can be used for contrastive learning is the cross entropy loss.

FIGS. 8A-8B are block diagrams illustrating an example of a machine learning (ML) model 800 for training according to one embodiment. Model 800 can be representative of a trainable ML model for real-time object (obstacle) detection. In one embodiment, model 800 combines contrastive learning with transfer learning for a few shot learning so that model 800 is adapted to a new domain (e.g., new ISP algorithms) using a sparse dataset (few shot data). Once trained, model 800 can be adapted to process images from the new domain, e.g., ISP algorithms (e.g., ISP I, ISP II, or ISP III).

In one embodiment, model 800 can include a transfer neural network (NN) module 805 and a perception neural network (NN) module 807. Transfer NN module 805 can encode features of baseline ISP algorithm and/or new ISP algorithms so to capture agreeable features among same class of objects and contrast features among different classes of objects. Perception NN module 807 can predict a class for each object in an image and predict a bounding box for each object. Transfer NN module 805 can then cause perception NN module 807 to adapt from a baseline image set to new image sets corresponding to new ISP algorithms I, II, and/or III.

In one embodiment, transfer NN module 805 can include a plurality of convolutional neural network layers 813, 819 connected in a series manner. A convolutional layer can include one or more filters having trainable parameters (e.g., weights and biases) that are updatable during training. The height and weight dimensions of the filters can be smaller than that of the input tensor for the respective layer. For a convolutional layer, each filter is convolved with the input tensor to compute an activation map to be used by a next layer. The filters can be convolved with the input tensor in strides. The stride can be any values, e.g., 1, 2, 4, etc. that can capture the differentiating features from the different ISP algorithms. Each convolutional layer can include an activation function, such as a rectifier linear (ReLU), sigmoid, tanh, or any other activation function. In one embodiment, transfer NN module 805 can include maxpool layers 815 disposed between any of the hidden convolutional layers. During training, a layer or one or more nodes within a layer can be dropped out to prevent overfitting.

In one embodiment, transfer NN module 805 can include maxpool layers 815 and/or deconvolutional (or transposed convolutional) layers 817 connected before or after convolutional layers 813, 819. For example, in one embodiment, maxpool layers 815 and/or deconvolutional layers 817 can be include between one or more convolutional layers to keep output layer 821 (e.g., output tensor) of transfer NN module 805 to be of a same size as input layer 811. In one embodiment, transfer NN module 805 includes one or more fully connected layers 820. For example, a fully connected layer 820 can be coupled between a convolutional layer 819 and an output layer 821. Output layer 821 can represent the output feature map for the transfer NN module 805. Output layer 821 can then be used as the input for perception NN module 807.

Perception NN module 807 can be previously trained for real-time obstacle detection using an image set from a baseline ISP algorithm. In one embodiment, perception NN module 807 can include a plurality of hidden convolutional layers followed by one or more fully connected layers. In one embodiment, perception NN module 807 can include hidden drop-out layers disposed between any of the hidden convolution layers to prevent overfitting. An example of a perception NN module 807 can be the YOLO real-time object detection NN model.

During training, engine 122 can freeze the trainable weights of the perception module 807 so the training would not degrade existing task performance by the perception module 807 and only update the trainable parameters (e.g., weights and biases) for the transfer NN module 805.

For example, a prediction result for the model 800 can be:

pⱼ=softmax(g(f(x))),

where pⱼ is the prediction result, f(x) denotes the feature vectors extracted by the pretrained perception CNN, and g(x) denotes the feature vectors extracted by the transfer CNN, x denotes the input tensor (e.g., a batch of image(s)).

During training, engine 122 can forward propagate and calculates pⱼ. From the calculated pⱼ, engine 122 can backward propagates and updates the weights/biases for transfer NN module 805 using a cross entropy loss function. In one embodiment, the cross entropy loss function can be represented by:

$$min {\sum }_{j} CrossEntropy ( {y}_{j} , {p}_{j} )$$

where yⱼ denotes the expected prediction label, p₁ denotes the prediction result, cross entropy denotes the cross entropy loss to be minimized between the expected label yⱼ and the calculated result pⱼ, and j denotes the jth training sample.

Here, the cross entropy loss 809 can be applied to a classification score and/or a perception score. For example, the classification score can correspond to the class of ISP algorithms, e.g., baseline, algorithm I, algorithm II, and/or algorithm III. The perception score can correspond to the inferred probability output of a corresponding class (e.g., bike, truck, car, pedestrian, traffic light) for a detected object.

In one embodiment, the cross entropy (CE) loss can be applied to positive or negative pair samples. For a positive pair sample, CE loss can be applied to a labeled bike in an image corresponding to a baseline ISP algorithm and a labeled bike in an image corresponding to a proposed ISP algorithm I, II, and/or III. The CE loss can be minimized during training to cause the embeddings or feature vectors of the positive image pairs to be similar. For a negative pair sample, CE loss can be applied to a labeled non-bike class (e.g., car, truck, pedestrian, traffic light) in an image corresponding to a baseline ISP algorithm and a labeled bike in an image corresponding to a proposed ISP algorithm I, II, or III. The CE loss can be minimized during training to cause the embeddings or feature vectors of the negative image pairs to be dissimilar. Through training iterations, transfer NN module 805 can learn to adapt to features from the proposed ISP algorithm I, II, or III, while keeping the trainable weights of perception module 807 fixed (frozen). Note that the CE loss function measures how much a model deviates from a correct prediction.

In another embodiment, the trainable parameters (weights and/or biases) of transfer NN module 805 is updated using the CE loss as a type of contrastive loss taking into account the positive and negative sample pairs. An example of a contrastive loss function for the CE loss can be:

$${l}_{contrastive} ( i , j ) = - log \frac{exp ( \frac{{p}_{ii}}{τ} )}{{\sum }_{j = 1 , i \neq j} exp ( \frac{pij}{τ} )}$$

where qᵢᵢ=pᵢ·qᵢ denotes a dot product between p and q feature vectors from two positive sample pairs 801 and pᵢⱼ=pᵢ·qⱼ denotes a dot product between p and q feature vectors from two negative sample pairs 803, i denotes an ith labeled data from a newly proposed ISP algorithm, j denotes the jth labeled data from the baseline ISP algorithm, r denotes a tuning hyperparameter.

As described by the contrastive loss function, ML engine 122 can back propagate and update trainable parameters for transfer module 805 to minimize a distance between feature vectors for the positive sample pairs while maximizing a distance between feature vectors for the negative sample pairs.

In one embodiment, the cross entropy loss can be further applied to the perception score in combination to the classification score. The perception score refers to the probability that an object is of a particular class at the output of perception NN module 807. For obstacles of a same class, the cross entropy loss can be applied during training to update the trainable parameters of transfer NN module 805 to minimize a different between a perception score for images from a new ISP algorithm and a perception score for images from the baseline ISP algorithm.

An example of the loss function for the perception score can be:

minΣCrossEntropy(s₁,s₂)

where s₁ denotes the perception score corresponding to a new ISP algorithm, s₂ denotes the perception score corresponding to the baseline ISP algorithm. Minimizing the perception score for each labeled data in the new ISP algorithm with a corresponding class of the baseline ISP algorithm causes the model to adapt to the new ISP algorithm.

In one embodiment, during training, the positive and/or negative sample pairs can be provided to the model 800 in batches with an input tensor dimension of B*C*W*H, where B denotes to the batch size, C denotes the channel size, W denotes the input width dimension, H denotes the input height dimension. The loss function(s) can be applied at the output of perception module 807 according to the above one or more CE loss equation(s) for the classification score and/or perception scores to update the weight/bias parameters of transfer NN module 805. Once trained, transfer module model 805 is adaptive to the features of the newly proposed ISP algorithms I, II, III and module 800 can be used for real-time object detection using images generated by the ISP algorithms I, II, or III. In one embodiment, detected obstacles are classified by model 800 with bounding boxes. A location (bounding box) and/or classification of the detected obstacles are used by decision and planning modules of the ADV to control (path and speed) the ADV autonomously.

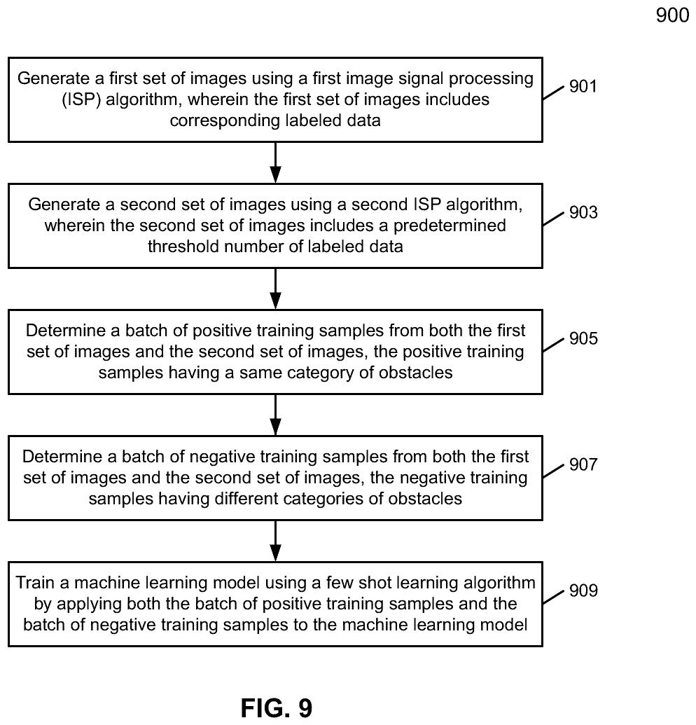

FIG. 9 is a flow diagram illustrating a process to train a ML model using few shot learning of according to one embodiment. Process 900 may be performed by processing logic which may include software, hardware, or a combination thereof. For example, process 900 may be performed by ML engine 122 of FIG. 4.

Referring to FIG. 9, at block 901, processing logic determines a first set of images corresponding to a first image signal processing (ISP) algorithm (e.g., ISP algorithm I, II, or III), where the first set of images includes corresponding labeled data.

At block 903, processing logic determines a second set of images corresponding a second ISP algorithm (e.g., baseline ISP algorithm), where the second set of images includes a predetermined threshold number of labeled data.

At block 905, processing logic determines a batch of positive training samples from both the first set of images and the second set of images, the positive training samples having a same category of obstacles.

At block 907, processing logic determines a batch of negative training samples from both the first set of images and the second set of images, the negative training samples having different categories of obstacles.

At block 909, processing logic trains a machine learning model using a few shot learning algorithm by applying the batch of positive training samples and the batch of negative training samples to the machine learning model. The machine learning model is used to detect an obstacle in an image that is generated using either the first or the second ISP algorithm, where the first or second ISP algorithm is applied to raw image data of a camera of an autonomous driving vehicle (ADV) to generate the image for perception tasks of the ADV.

In one embodiment, the machine learning model includes a transfer network and a perception network, where an output of the transfer network is coupled to an input of the perception network.

In one embodiment, the transfer network or the perception network includes a deep convolutional neural network model, where a deep convolutional neural network model includes a plurality of convolutional layers.

In one embodiment, a plurality of weights of the transfer network is configured to be trainable and a plurality of weights of the perception network is configured to be frozen during training.

In one embodiment, the transfer network encodes representation features for both the first and second ISP algorithms.

In one embodiment, the machine learning model is trained using cross entropy loss for a classification score and/or a perception score, where the classification score and/or perception score is determined based on the batch of positive and negative training samples.

In one embodiment, the classification score corresponds to a plurality of ISP algorithms and the perception score corresponds to a plurality of types of obstacles to be detected.

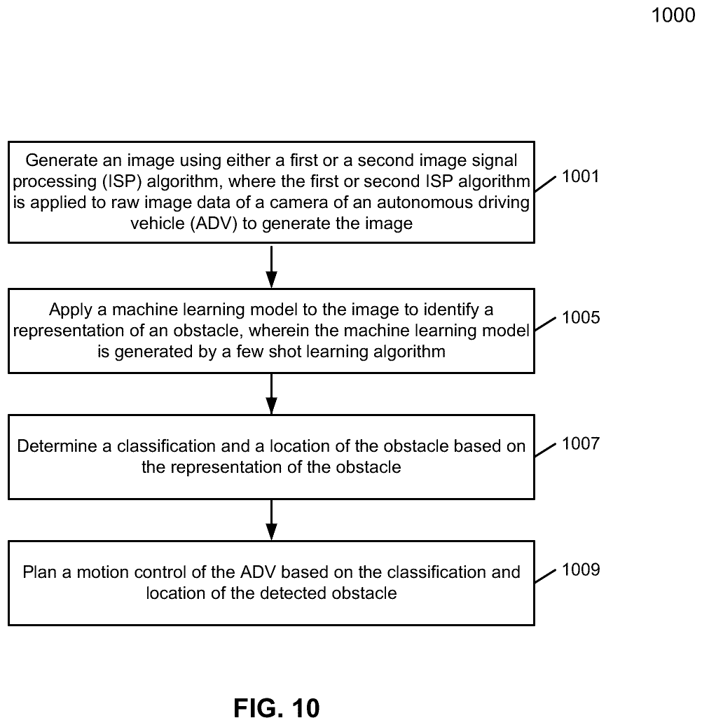

FIG. 10 is a flow diagram illustrating a process to perform inference using a ML model according to one embodiment. Process 1000 may be performed by processing logic which may include software, hardware, or a combination thereof. For example, process 1000 may be performed by obstacle perception module 308 of FIG. 5.

Referring to FIG. 10, at block 1001, processing logic receives an image corresponding to either a first or a second image signal processing (ISP) algorithm, where the first or second ISP algorithm is applied to raw image data of a camera of an autonomous driving vehicle (ADV) to generate the image.

At block 1003, processing logic applies a machine learning model to the image to identify a representation of an obstacle, where the machine learning model is generated by a few shot learning algorithm that contrasts labeled data of a positive training sample from images corresponding to the first and second ISP algorithms to labeled data of a negative training sample from images corresponding to the first and second ISP algorithms.

At block 1005, processing logic determines a classification and a location of the obstacle based on the representation of the obstacle.

At block 1007, processing logic plans a motion control of the ADV based on the classification and location of the obstacle.

In one embodiment, the machine learning model includes a transfer network and a perception network, where an output of the transfer network is coupled to an input of the perception network.

In one embodiment, the transfer network or the perception network includes a deep convolutional neural network model, where the deep convolutional neural network model includes a plurality of convolutional layers.

In one embodiment, a plurality of weights of the transfer network is configured to be trainable and a plurality of weights of the perception network is configured to be frozen during training.

In one embodiment, the transfer network encodes representation features from both the first and second ISP algorithms.

In one embodiment, the machine learning model is trained using cross entropy loss for a classification score and/or a perception score, where the classification score and/or perception score is determined based on a batch of positive training samples and a batch of negative training samples.

In one embodiment, the classification score corresponds to classification for a plurality of ISP algorithms and the perception score corresponds to classification for a plurality of types of obstacles to be detected.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
receiving an image corresponding to either a first or a second image signal processing (ISP) algorithm, wherein the first or second ISP algorithm is applied to raw image data of a camera of an autonomous driving vehicle (ADV) to generate the image;
applying a machine learning model to the image to identify a representation of an obstacle, wherein the machine learning model is generated by a few shot learning algorithm that contrasts labeled data of a positive training sample from images corresponding to the first and second ISP algorithms to labeled data of a negative training sample from images corresponding to the first and second ISP algorithms;
determining a classification and a location of the obstacle based on the representation of the obstacle; and
planning a motion control of the ADV based on the classification and location of the obstacle.

2. The method of claim 1, wherein the machine learning model includes a transfer network and a perception network, wherein an output of the transfer network is coupled to an input of the perception network.

3. The method of claim 2, wherein the transfer network or the perception network includes a deep convolutional neural network model, wherein the deep convolutional neural network model includes a plurality of convolutional layers.

4. The method of claim 2, wherein a plurality of weights of the transfer network is configured to be trainable and a plurality of weights of the perception network is configured to be frozen during training.

5. The method of claim 2, wherein the transfer network encodes representation features from both the first and second ISP algorithms.

6. The method of claim 1, wherein the machine learning model is trained using cross entropy loss for a classification score and/or a perception score, wherein the classification score and/or perception score is determined based on a batch of positive training samples and a batch of negative training samples.

7. The method of claim 6, wherein the classification score corresponds to classification for a plurality of ISP algorithms and the perception score corresponds to classification for a plurality of types of obstacles to be detected.

8. A computer-implemented method, comprising:
determining a first set of images corresponding to a first image signal processing (ISP) algorithm, wherein the first set of images includes corresponding labeled data;
determining a second set of images corresponding a second ISP algorithm, wherein the second set of images includes a predetermined threshold number of labeled data;
determining a batch of positive training samples from both the first set of images and the second set of images, the positive training samples having a same category of obstacles;
determining a batch of negative training samples from both the first set of images and the second set of images, the negative training samples having different categories of obstacles;
training a machine learning model using a few shot learning algorithm by applying the batch of positive training samples and the batch of negative training samples to the machine learning model, wherein the machine learning model is used to detect an obstacle in an image that is generated using either the first or the second ISP algorithm, wherein the first or second ISP algorithm is applied to raw image data of a camera of an autonomous driving vehicle (ADV) to generate the image for perception tasks of the ADV.

9. The method of claim 8, wherein the machine learning model includes a transfer network and a perception network, wherein an output of the transfer network is coupled to an input of the perception network.

10. The method of claim 9, wherein the transfer network or the perception network includes a deep convolutional neural network model, wherein a deep convolutional neural network model includes a plurality of convolutional layers.

11. The method of claim 9, wherein a plurality of weights of the transfer network is configured to be trainable and a plurality of weights of the perception network is configured to be frozen during training.

12. The method of claim 9, wherein the transfer network encodes representation features for both the first and second ISP algorithms.

13. The method of claim 8, wherein the machine learning model is trained using cross entropy loss for a classification score and/or a perception score, wherein the classification score and/or perception score is determined based on the batch of positive and negative training samples.

14. The method of claim 13, wherein the classification score corresponds to a plurality of ISP algorithms and the perception score corresponds to a plurality of types of obstacles to be detected.

15. A non-transitory machine-readable medium having instructions stored therein, which when executed by a processor, cause the processor to perform operations, the operations comprising:
determining a first set of images corresponding to a first image signal processing (ISP) algorithm, wherein the first set of images includes corresponding labeled data;
determining a second set of images corresponding to a second ISP algorithm, wherein the second set of images includes a predetermined threshold number of labeled data;
determining a batch of positive training samples from both the first set of images and the second set of images, the positive training samples having a same category of obstacles;
determining a batch of negative training samples from both the first set of images and the second set of images, the negative training samples having different categories of obstacles;
training a machine learning model using a few shot learning algorithm by applying the batch of positive training samples and the batch of negative training samples to the machine learning model, wherein the machine learning model is used to detect an obstacle in an image that is generated using either the first or the second ISP algorithm, wherein the first or second ISP algorithm is applied to raw image data of a camera of an autonomous driving vehicle (ADV) to generate the image for perception tasks of the ADV.

16. The non-transitory machine-readable medium of claim 15, wherein the machine learning model includes a transfer network and a perception network, wherein an output of the transfer network is coupled to an input of the perception network.

17. The non-transitory machine-readable medium of claim 16, wherein the transfer network or the perception network includes a deep convolutional neural network model, wherein a deep convolutional neural network model includes a plurality of convolutional layers.

18. The non-transitory machine-readable medium of claim 16, wherein a plurality of weights of the transfer network is configured to be trainable and a plurality of weights of the perception network is configured to be frozen during training.

19. The non-transitory machine-readable medium of claim 16, wherein the transfer network encodes representation features for both the first and second ISP algorithms.

20. The non-transitory machine-readable medium of claim 15, wherein the machine learning model is trained using cross entropy loss for a classification score and/or a perception score, wherein the classification score and/or perception score is determined based on the batch of positive and negative training samples.
